(19) United States
(12) Patent Application Publication
(10) Pub. No.: US 2003/0069732 A1
(43) Pub. Date: Apr. 10, 2003

(54) Method for creating a personalized animated storyteller for audibilizing content

(75) Inventors: Thomas M. Stephany, Churchville, NY (US); Donald E. Olson, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 09/973,032

(22) Filed: Oct. 9, 2001

(51) Int. Cl. G10L 21/00; G10L 11/00

(52) U.S. Cl. 704/270

(57) ABSTRACT

A method for creating a personalized animated storyteller for audibilizing content, the method comprises the steps of converting a digital image into a wire mesh and a texture model; providing instruction for directing the wire mesh; selecting or creating the content to be made audible; and directing the instructions to move the wire mesh in accordance with the selected content and to audibilize the selected or created content in synchronization with the wire mesh for providing the storyteller that audibilizes the content.

### FIELD OF THE INVENTION

The invention relates generally to the field of animations and, more particularly, to using an animation as a personalized storyteller on a computer.

### BACKGROUND OF THE INVENTION

The use of animations to deliver entertainment, educational content and specific messages is known. For example, an animation of Smokey the Bear was used to teach the public to be careful of starting forest fires. The viewing of cartoons on television has been further demonstrated to be an effective tool for entertainment and learning. Additionally, the use of an animation to tell a personalized story has been accomplished previously, as in Snow White and the Seven Dwarfs by the Walt Disney Company, but the animation, once created, can tell only a specific story. Once the animation is created, it is extremely costly to author or change the content of the story, since you also have to re-do the animation.

Therefore, a need exists to inexpensively create and change the contents of an animation.

### SUMMARY OF THE INVENTION

The present invention is directed to overcoming one or more of the problems set forth above. Briefly summarized, according to one aspect of the present invention, the invention resides in a method for creating a personalized animated storyteller for audibilizing content, the method comprising the steps of (a) converting a digital image into a wire mesh and a texture model; (b) providing instruction for directing the wire mesh; (c) selecting the content to be made audible; and (d) directing the instructions to move the wire mesh in accordance with the selected content and to audibilize the selected content in synchronization with the wire mesh for providing the storyteller that audibilizes or delivers the content.

These and other aspects, objects, features and advantages of the present invention will be more clearly understood and appreciated from a review of the following detailed description of the preferred embodiments and appended claims, and by reference to the accompanying drawings.

### ADVANTAGEOUS EFFECT OF THE INVENTION

The present invention has the following advantage of inserting a personalized storyteller into a story such as Snow White. This animated insert serves as a vehicle to further audibilize a description of the action therein, and can be readily changed in an effort to allow for customization or personalization of the inserted storyteller.

### BRIEF DESCRIPTION OF THE DRAWINGS

FIG. 1 is an illustration of a kiosk of the present invention;

FIG. 2 is a flowchart of a software program of the present invention that is implemented of the kiosk of FIG. 1; and

FIG. 3 is a typical frame from an animated story.

### DETAILED DESCRIPTION OF THE INVENTION

In the following description, a portion of the present invention will be described in the preferred embodiment as a software program. Those skilled in the art will readily recognize that the equivalent of such software may also be constructed in hardware.

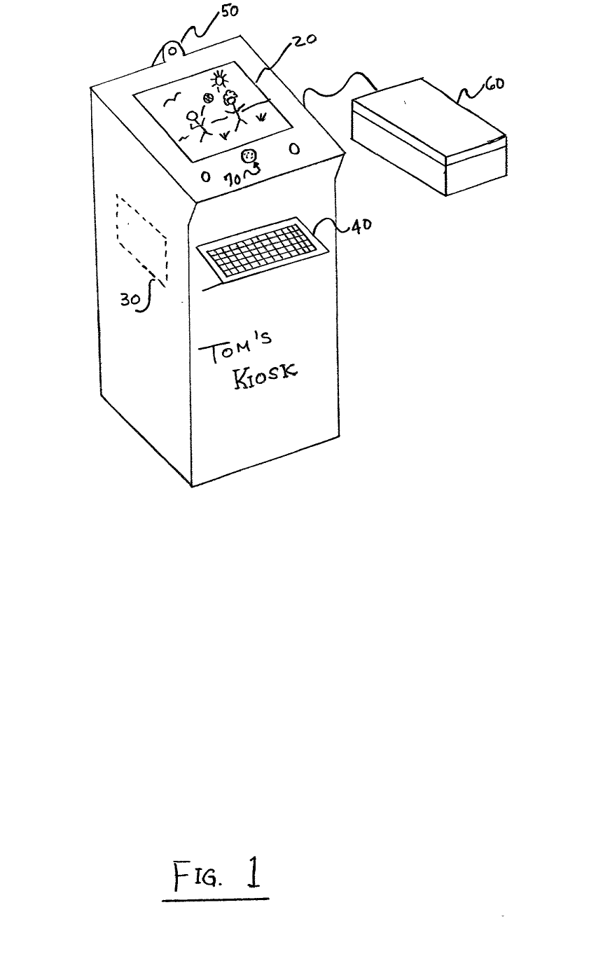

Referring to FIG. 1, there is shown a kiosk 10 for implementing the present invention. The kiosk 10 includes a monitor 20 for displaying text, images, graphics and the like to a user. A microprocessor with memory 30 is disposed in the interior of the kiosk 10 for processing and executing software programs necessary for operating the kiosk 10. The kiosk 10 also includes a keyboard 40 for permitting the user to input their directions and selections for execution. A digital camera 50 is disposed at an upper portion of the kiosk 10 for capturing an image of the user for obtaining an image to be used as a storyteller, as described in detail hereinbelow. A scanner 60 could additionally be connected to the kiosk 10 for converting a conventional image into a digital image file, which is then supplied to the kiosk 10. A microphone 70 is also connected to the kiosk 10 for receiving audible input from the user.

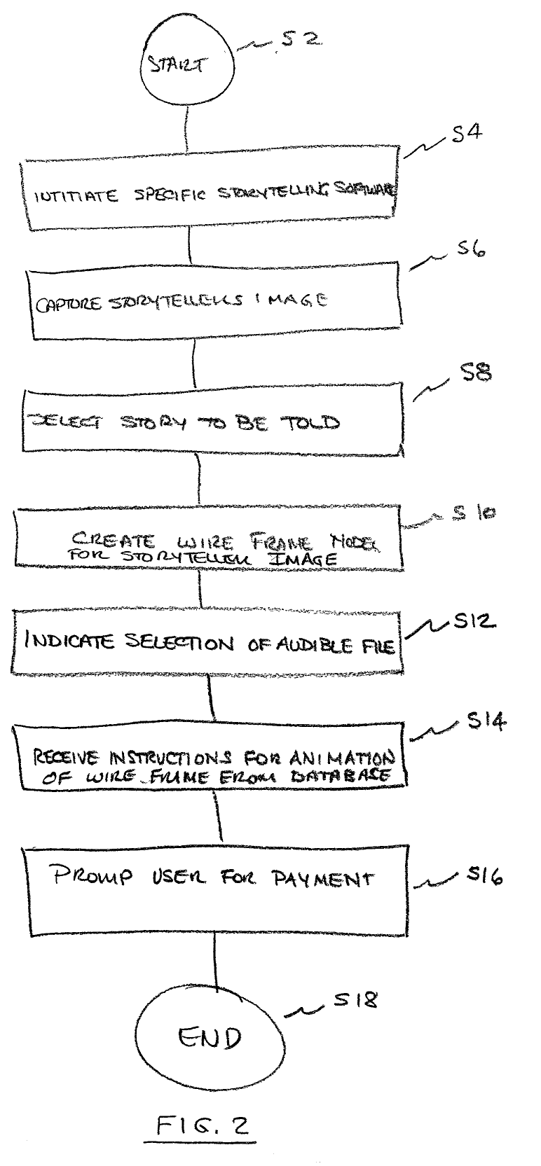

Referring to FIG. 2, there is shown the flowchart of a software program of the present invention. The system control software is started S2 by pressing any key on the keyboard 40, (FIG. 1). The specific storytelling program software S4 is initiated by the user by selecting a designated key on the keyboard 40. The user is then prompted S6 to indicate whether an image is to be captured by the digital camera 50 (FIG. 1), or to be digitized by the scanner 60 (FIG. 1), as the storyteller image. If a conventional image is supplied, the scanner 60 digitizes the image, and in the case of an image to be captured, the digital camera 50 captures the image of the user. It facilitates understanding to note that the selected image will used as the animated foreground of the displayed image in the narrated story.

The user is then prompted S8 to select a story from a list of stories displayed on the monitor as the story to be narrated. For example, a movie-version cartoon of a story, such as Walt Disney's Snow White and the Seven Dwarfs, would be displayed as the background. It should be understood by people skilled in the art that photo-realistic animation could be used in lieu of the movie-version cartoon. For example, a description of the assembly of a bicycle could be substituted for the movie Snow White and Seven Dwarfs. A wire frame and texture model are then created S10 from the digital image file. The user is prompted S12 to indicate the selection of the audible file to narrate the story, either a stored audible file or the audible file of the user. The stored audible files are obviously stored in the kiosk's memory, and for a customized audible file, the user verbally reads the story or information into the microphone, which is converted into a digital audible file. Additionally, a user could select a pre-recorded narrative of the story, which could be alternatively used.

Instructions for the movement of the texture model and wire mesh are obtained S14 by retrieving the instructions from a database, which stores all of the instructions for each story. In the case of a customized story, the database also stores a plurality of commonly used words, which are matched to the received input. In the case of non-matched words, the software matches to the closest word in the database by comparing syllables, and outputs this as the instruction for that particular word. These instructions are then stored for use as the animation instructions created S10 for the wire frame, the background imaging being the previously selected story S8.

The user is then prompted S16 for payment and delivery instructions and the software is then terminated S18 until initiated again by another user.

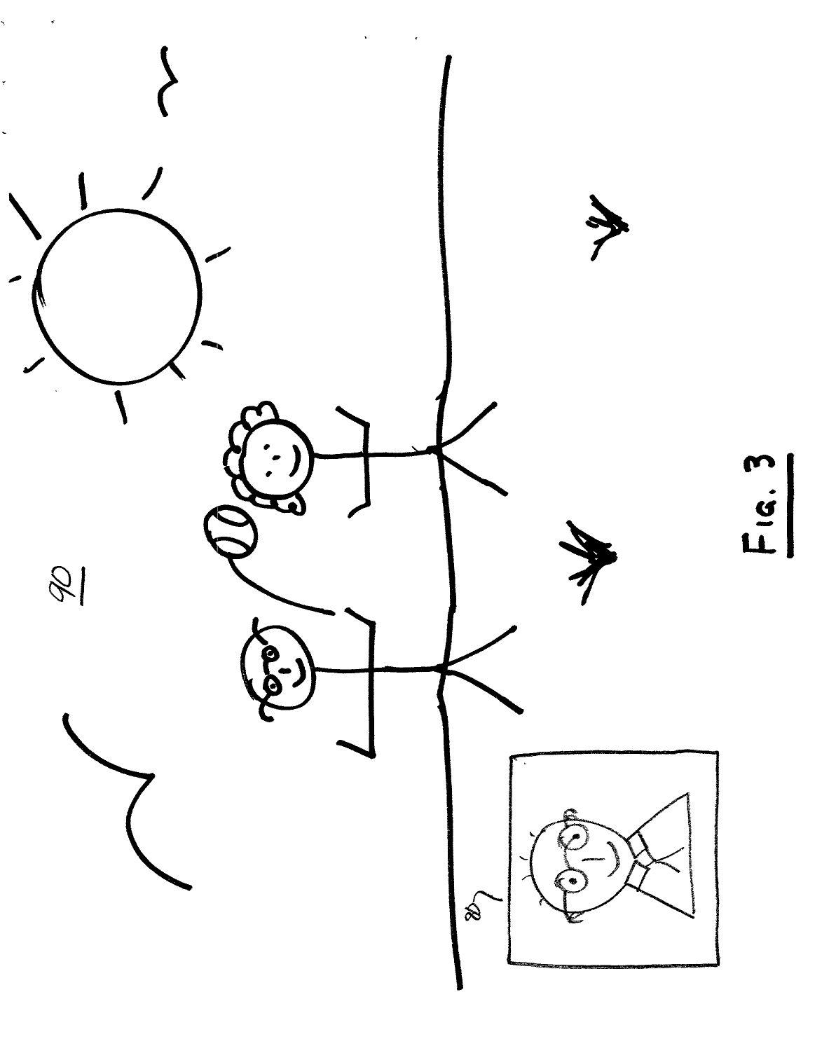

Referring to FIG. 3, there is shown an illustration of a typical frame from a completed animated storyteller. The frame includes a typical foreground 80 and a typical background 90. It should be understood by people skilled in the art that photo-realistic animation could be used in lieu of the movie-version cartoon. In this case, the foreground would be an audibilized detailed description of the assembly spoken by a person or character. The background, in this case, could be a still image.

The invention has been described in detail with particular reference to certain preferred embodiments thereof, but it will be understood that variations and modifications can be effected within the spirit and scope of the invention.

Parts List

10 kiosk

20 monitor

30 microprocessor

40 keyboard

50 digital camera

60 scanner

70 microphone

80 foreground

90 background

What is claimed is:

1. A method for creating a personalized animated storyteller for audibilizing content, the method comprising the steps of:
(a) converting a digital image into a wire mesh and a texture model;
(b) providing instruction for directing the wire mesh;
(c) selecting or creating the content to be made audible; and
(d) directing the instructions to move the wire mesh in accordance with the selected content and to audibilize the selected or created content in synchronization with the wire mesh for providing the storyteller that audibilizes the content.

2. The method as in claim 1 further comprising obtaining a voice sample of the user sufficient to produce an audio file having a full range of the users voice necessary to audibilize the content.

3. The method as in claim 2, wherein step (c) includes selecting a children's story to be made audible.

4. The method as in claim 2, wherein step (c) includes selecting educational material or customized content to be made audible.

5. The method as in claim 1 further comprising providing animated characters in a background which enact content and providing an animated storyteller in a foreground as the content is audibilized.
